(19) United States
(12) Patent Application Publication
(10) Pub. No.: US 2010/0147549 A1
(43) Pub. Date: Jun. 17, 2010

(54) FLAME RETARDANT CABLE

(75) Inventor: Kazuto SHIINA, Kanuma-shi (JP)

Correspondence Address: GLOBAL IP COUNSELORS, LLP, 1233 20TH STREET, NW, SUITE 700, WASHINGTON, DC, 20036-2680, US

(73) Assignee: SUMITOMO ELECTRIC INDUSTRIES, LTD., Osaka (JP)

(21) Appl. No.: 12/628,018

(22) Filed: Nov. 30, 2009

(30) Foreign Application Priority Data
Dec. 16, 2008 (JP) 2008-319836

(51) Int. Cl. H01B 7/295; H01B 7/00

(52) U.S. Cl. 174/113 C; 174/120 SR

(57) ABSTRACT

There is provided a flame-retardant cable that has exceptional abrasion resistance and flame retardancy, and that is highly reliable as wiring for connecting various systems in a vehicle. The flame-retardant cable comprises an insulated core part; an inner sheath for covering an outer perimeter of the insulated core part, the inner sheath being a first resin composition having as a primary component 100 parts by weight of an ethylene-vinyl acetate copolymer, to which has been added 1 to 5 parts by weight of an ethylene-acrylate maleic anhydride copolymer; and an outer sheath for covering an outer perimeter of the inner sheath, the outer sheath being a second resin composition having a thermoplastic polyurethane elastomer as a primary component, to which melamine cyanurate has been added.

### TECHNICAL FIELD

The present invention relates to a flame-retardant cable having a flame-retardant sheath outside an insulated core part.

### BACKGROUND ART

Antilock brake systems (ABS) have been fitted in automotive vehicles in recent years in order to improve safety. An ABS comprises a wheel speed sensor for detecting the rotational speed of the wheel; an engine control unit (ECU) for performing calculations on the signal produced by the wheel speed sensor; and an actuator that is operated by an output signal from the ECU. The signal produced by the wheel speed sensor is transmitted to the ECU via an ABS sensor cable. The output signal of the ECU causes the actuator to operate, whereby the brake is controlled. International Disclosure No. 05/013291 discloses an ABS sensor cable having a structure in which the outer perimeter of a twisted pair of insulated wires is covered by an insulating resin.

Exceptional abrasion resistance is needed for cables such as ABS sensor cables that are used in vehicles. Materials that have exceptional mechanical strength; e.g., thermoplastic polyurethane elastomers, are used for the sheath that covers the outer perimeter of the cable. On the other hand, exceptional flame retardancy is also needed for cables used in vehicles. However, the abrasion resistance of the sheath may decrease when magnesium hydroxide or other flame retardants are added to resins formed from elastomer mixtures.

### DISCLOSURE OF THE INVENTION

It is an object of the present invention to provide a cable that has exceptional abrasion resistance and flame retardancy, and that is highly reliable as wiring for connecting various systems in a vehicle.

In order to achieve the object, there is provided a flame-retardant cable, comprising an insulated core part; an inner sheath for covering an outer perimeter of the insulated core part, the inner sheath being a first resin composition having as a primary component 100 parts by weight of an ethylene-vinyl acetate copolymer, to which has been added 1 to 5 parts by weight of an ethylene-acrylate maleic anhydride copolymer; and an outer sheath for covering an outer perimeter of the inner sheath, the outer sheath being a second resin composition having a thermoplastic polyurethane elastomer as a primary component, to which melamine cyanurate has been added. In the flame-retardant cable of the present invention, the insulated core part preferably comprises a plurality of twisted insulated wires.

The abrasion resistance of the inner sheath is improved in the flame-retardant cable of the present invention. As a result, the entire cable has exceptional abrasion resistance. The outer sheath is characterized by exceptional flame retardancy. The flame-retardant cable of the present invention can therefore be used as wiring for connecting various systems in a vehicle where good reliability is needed.

### BRIEF DESCRIPTION OF THE DRAWINGS

FIG. 1 is a cross-sectional view that shows a flame-retardant cable according to an embodiment of the present invention; and

FIG. 2 is a schematic diagram that depicts the abrasion-resistance test of JASO D 608-92.

### BEST MODE OF CARRYING OUT THE INVENTION

Embodiments of the present invention will be described below with reference to the drawings. The drawings are not necessarily drawn to a scale that accurately reflects the actual components.

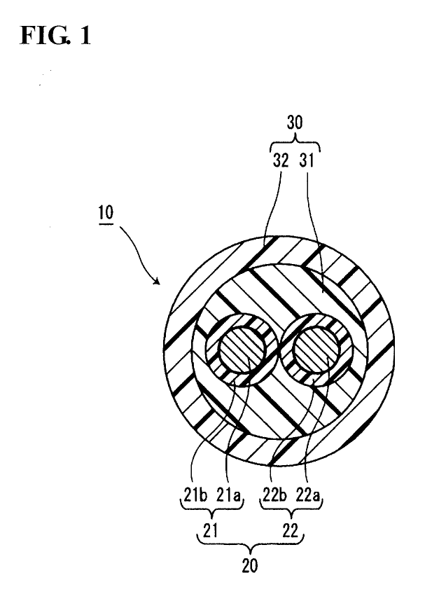

FIG. 1 is a cross-sectional view that shows a flame-retardant cable 10 according to an embodiment of the present invention. The flame-retardant cable 10 has an insulated core part 20 and a sheath 30, which is formed on the outside of the insulated core part 20. The insulated core part 20 contains a twist pair of insulated wires 21, 22. The insulated wires 21, 22, respectively, are composed of conductors 21a, 22a and insulators 21b, 22b that cover the perimeter of the respective conductors. The sheath 30 has an inner sheath 31, which covers the outer perimeter of the insulated core part 20, and an outer sheath 32, which covers the outer perimeter of the inner sheath 31. The inner sheath 31 and the outer sheath 32 are sequentially extruded so as to cover the perimeter of the insulated core part 20, whereby the flame-retardant cable 10 having this structure is manufactured.

The inner sheath 31 is formed from a first resin composition in which a polyolefin resin is the primary component. A specific example of the first resin composition is a resin composition having an ethylene-vinyl acetate copolymer, which has high mechanical strength and exceptional abrasion resistance, as the primary component, and 1 to 5 parts by weight of an ethylene-acrylate maleic anhydride copolymer is added to 100 parts by weight of the ethylene-vinyl acetate copolymer. The inclusion of the ethylene-acrylate maleic anhydride copolymer in the first resin composition improves the abrasion resistance of the outer sheath 32 and imparts exceptional abrasion resistance to the entirety of the flame-retardant cable 10. An example of the ethylene-acrylate maleic anhydride copolymer is Bondine® by Arkema.

The outer sheath 32 is formed from a second resin composition having a thermoplastic polyurethane elastomer as the primary component. The thermoplastic polyurethane elastomer in the second resin composition may be cross-linked or non-cross-linked.

Examples of the thermoplastic polyurethane elastomer include block copolymers in which the hard segment is a polyurethane part composed of 4,4′-diphenylmethane diisocyanate (MDI), toluene-diisocyanate (TDI), or another diisocyanate and ethylene glycol or another diol, and the soft segment is polyether, polyester, polycarbonate, or another amorphous polymer. Among these copolymers, polyether thermoplastic polyurethane elastomers are ideally used due to characteristics of, e.g., pliability, resistance to hydrolysis, and low-temperature bending.

A halogen-free flame retardant is added to the second resin composition. Preferable halogen-free flame retardants are metal-hydroxide materials (e.g., aluminum hydroxide and magnesium hydroxide) or nitrogen-containing flame retardants (e.g., melamine, melamine cyanurate, and melamine phosphate). Magnesium hydroxide is particularly preferable as a metal-hydroxide material, and melamine cyanurate is particularly preferable as a nitrogen-containing flame retardant.

Antioxidants, degradation-preventing agents, colorants, cross-linking aids, tackifiers, lubricants, softeners, fillers, processing aids, coupling agents, and the like may also be added to the first resin composition and the second resin composition.

Examples of antioxidants include phenol-containing antioxidants, amine-containing antioxidants, sulfur-containing antioxidants, and phosphite-ester-containing antioxidants. Examples of degradation-preventing agents include HALS (hindered-amine light stabilizers), ultraviolet-absorbing agents, metal-inactivating agents, and hydrolysis-preventing agents. Colorants are added in order to impart other colors or in order to absorb ultraviolet rays. Examples include carbon black, titanium white, and other organic and inorganic pigments.

Cross-linking aids are not essential, but 1 to 10 parts by weight is preferably added in order to increase the efficiency of cross-linking. Examples of cross-linking aids include triallyl-isocyanurate, triallyl-cyanurate, trimethylol-propane-trimethacrylate, N,N′-metaphenylene-bismaleimide, ethylene glycol dimethacrylate, zinc acrylate, and zinc methacrylate.

Examples of tackifiers include coumarone-indene resin, polyterpene resin, xylene-formaldehyde resin, and hydrogenated rosin. Examples of other agents that can be added as necessary include lubricants such as fatty acids, unsaturated fatty acids, metal salts thereof, fatty-acid amides, and fatty-acid esters; softeners such as mineral oil, vegetable oil, and plasticizers; fillers such as calcium carbonate, talc, clay, silica, zinc oxide, and molybdenum oxide; and, other than silane coupling agents, coupling agents such as isopropyl-triisostearoyl titanate, isopropyl(N-aminoethyl-aminoethyl)titanate, and other titanate-containing coupling agents.

A halogen-free flame retardant is added to polyurethane, which is the primary component, whereby flame retardancy is imparted to the outer sheath 32. Although the abrasion resistance of the outer sheath is poor due to adding the flame retardant, the inner sheath 31 has exceptional abrasion resistance, and as a result, the entirety of the cable also has exceptional abrasion resistance. The cable can thereby be used as wiring for connecting various systems in a vehicle (e.g., as an ABS sensor cable) even in components for which higher reliability is needed.

### EXAMPLES

### Manufacture of the Material of the Inner Sheath

An ethylene-vinyl acetate copolymer and an ethylene-acrylate-maleic anhydride copolymer were mixed together in the amounts shown in Table 1, and then melted and mixed using a twin-screw mixer having a barrel diameter of 45 mm, where (effective length of screw L)/(screw diameter D)=32. The mixture was then fashioned into pellets using a method for performing water-cooled cutting on the discharged strands, and the material of the inner sheath was obtained.

Manufacture of the Material of the Outer Sheath

A thermoplastic polyurethane elastomer, melamine cyanurate, and a cross-linking aid were mixed together in the amounts shown in Table 1, and then melted and mixed using the aforedescribed twin-screw mixer. The mixture was then fashioned into pellets using a method for performing water-cooled cutting on the discharged strands, and the material of the outer sheath was obtained.

Manufacture of the Insulated Wire

A mixed composition of 100 parts by weight of linear low-density polyethylene (LLDPE; melting point: 122° C.; melt flow rate: 1.0), 80 parts by weight of magnesium hydroxide (average particle diameter: 0.8 μm; BET specific surface area: 8 m²/g) as a flame retardant, 0.5 parts by weight of Irganox 1010 (product name; Ciba Specialty Chemicals) as an antioxidant, and 3 parts by weight of trimethylol-propane-trimethacrylate was melted and mixed using the aforedescribed twin-screw mixer. The mixture was then fashioned into pellets using a method for performing water-cooled cutting on the discharged strands. A single-screw extruder (cylinder diameter: 30 mm; L/D=24) was used to extrude these pellets into a layer having an average thickness of 0.30 mm covering a strand-wire conductor having a cross-sectional area of 0.35 mm². An electron beam having an accelerating voltage of 1 MeV was then directed onto the layer at 150 kGy, and the insulated wire was manufactured.

Manufacture of the Cable

Two insulated wires obtained as described above were intertwined at a twist pitch of 30 mm, and a twisted pair was formed. A single-screw extruder (barrel diameter: 50 mm; L/D: 24) was then used to extrude the material of the inner sheath so as to cover the outer perimeter of the twisted pair to an external diameter of 3.4 mm. A single-screw extruder (barrel diameter: 50 mm; L/D: 24) was then used to extrude the material of the outer sheath so as to cover the outer perimeter of the inner sheath to an external diameter of 4.0 mm. An electron beam having an accelerating voltage of 2 MeV was then directed onto the outer sheath at 200 kGy, whereby a test cable was made.

Evaluation of the Cable

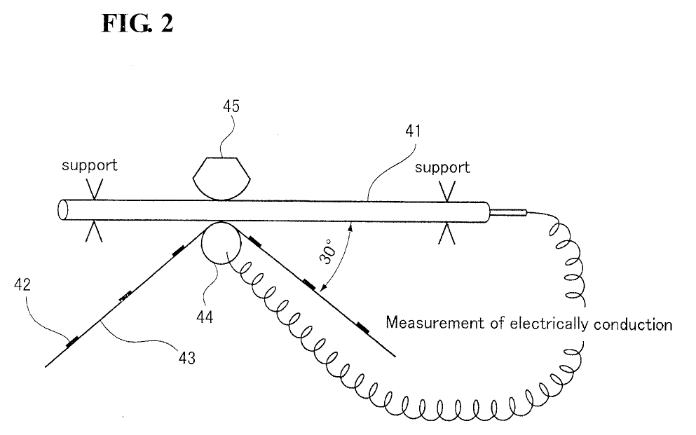

The abrasion resistance of the cable obtained using the method described above was evaluated according to “12. Abrasion resistance test, (1) Abrasive tape testing method” for heat-resistant low-voltage electrical wire for automotive vehicles according to JASO D 608-92. FIG. 2 is a schematic diagram that depicts the abrasion-resistance test of JASO D 608-92. In this test, a sample 41 having a length of 900 mm was taken from the cable and immobilized in a testing environment of 23±5° C. so that the sample 41 came into contact with sandpaper tape 43 having a roughness number of 150. Electrically-conductive parts 42 having a width of 10 mm were provided to the tape 43 at intervals of 150 mm. The sample 41 and the tape 43 were sandwiched by a roller 44 (diameter: 7 mm) and a load 45 (450 g; radius of curvature of pressing portion: 114 mm) at the point of contact.

The tape 43 was made to move at a speed of 1500 mm/min. The tape 43 approached the sample 41 at an angle of 30°. The direction in which the tape proceeded was changed by the roller 44, and the tape receded from the sample 41 at an angle of 30°. The length the sandpaper tape had moved until the internal conductor of the sample 41 and one of the electrically-conductive parts 42 came into contact was measured.

The length moved was measured 8 times for one cable, and the average value was determined. Only the measurement values that were less than the average value were re-averaged, and this value is deemed as the abrasion resistance. The results are shown in Table 1.

TABLE 1

| | | Example 1 | Example 2 |
|---|---|---|---|
| Inner sheath material | | | |
| Ethylene-vinyl acetate copolymer (EVA) | | 100 | 100 |
| Ethylene-acrylate maleic anhydride | | 5 | 1 |
| copolymer (Bondine) | | | |
| Outer sheath material | | | |
| Thermoplastic polyurethane elastomer | | 100 | 100 |
| Cross-linking aid | | 5 | 5 |
| Melamine cyanurate | | 50 | 50 |
| Abrasion resistance | m | 20 | 10 |

In comparison, the abrasion resistance was less than 10 m for a cable in which Bondine was not added to the material of the inner sheath. Given that an evaluation of satisfactory was awarded if the sandpaper moved a length of 10 m or more before the inner conductor of the insulated wires was exposed, an abrasion resistance evaluated to be satisfactory was obtained by using the first resin composition for the material of the inner sheath, where the first resin composition contains 1 to 5 parts by weight of an ethylene-acrylate maleic anhydride copolymer relative to 100 parts by weight of an ethylene-vinyl acetate copolymer. In cables in which 10 parts by weight of Bondine was added to the material of the inner sheath, the Bondine formed clumps and did not disperse uniformly, the abrasion resistance could not be measured, and the functionality as a cable was insufficient.

1. A flame-retardant cable, comprising:
an insulated core part;
an inner sheath for covering an outer perimeter of the insulated core part, the inner sheath being a first resin composition having as a primary component 100 parts by weight of an ethylene-vinyl acetate copolymer, to which has been added 1 to 5 parts by weight of an ethylene-acrylate-maleic anhydride copolymer; and
an outer sheath for covering an outer perimeter of the inner sheath, the outer sheath being a second resin composition having a thermoplastic polyurethane elastomer as a primary component, to which melamine cyanurate has been added.

2. The flame-retardant cable according to claim 1, wherein the insulated core part comprises a plurality of twisted insulated wires.
